(19) United States
(12) Patent Application Publication
(10) Pub. No.: US 2011/0282800 A1
(43) Pub. Date: Nov. 17, 2011

(54) GLOBAL MANUFACTURING STRATEGY OPTIMIZATION TOOL

(76) Inventors: Raman CHANDER, Tucson, AZ (US); Ritesh GUPTA, New Delhi (IN); Saurabh BHATNAGAR, Haryana (IN); Nitin KAKKAR, New Delhi (IN)

(21) Appl. No.: 12/892,097

(22) Filed: Sep. 28, 2010

Related U.S. Application Data
(60) Provisional application No. 61/333,477, filed on May 11, 2010.

(51) Int. Cl. G06Q 10/00

(52) U.S. Cl. 705/348

(57) ABSTRACT

Embodiments of the present invention provide for a seamless comparison of different global manufacturing strategies. In a specific embodiment of the invention, a computer-implemented method for analyzing a manufacturing scenario for an enterprise is provided. This method comprises a step of inputting a set of key cost inputs. The method additionally comprises a step of adjusting a set of manufacturing scenario levers to create a set of manufacturing scenario inputs. The method additionally comprises a step of synthesizing a scenario for simulation based on said set of manufacturing scenario inputs. The method additionally comprises a step of obtaining a result of said scenario for said enterprise by simulating said scenario using said key cost inputs.

### CLAIM OF PRIORITY

This application claims priority to the provisional application entitled, “Global Manufacturing Strategy Optimization Tool”, filed May 11, 2010, Application No. 61/333,477.

### FIELD OF THE INVENTION

The invention relates generally to supply chain management systems and more specifically to manufacturing strategy visualization and optimization software.

### BACKGROUND OF THE INVENTION

Modern day companies have supply chains that stretch to every corner of the globe. Simple commodities consumed in the any given state in the United States may be produced in a factory as close as a neighboring state, or as far off as China. More complicated products such as cell phones are constructed and distributed through vast networks that span the globe and contain components that have widespread supply chains of their own. The administration and optimization of these leviathan supply chains is a daunting task that consumes considerable resources in the offices of multinational companies. Entire enterprises have flourished or fallen based on their ability to adapt their supply chain to the constant changes of the global marketplace.

Supply chain management systems are needed to allow organizations to collaborate across their management structures to assure that their supply chains continue to operate smoothly and adapt to changes in the global economy. These systems may be custom built and integrated into a company's enterprise software or they may be purchased off-the-shelf and customized in-house. A large team of personnel is required to keep the management system running by assuring that data regarding the company's supply chain is continuously fed to the system. This same team must also spend a considerable amount of time mining the data to provide management with information regarding the performance of the company's supply chain.

Supply chain management systems can also be used to make strategic decisions regarding a company's manufacturing and distribution systems. In addition, specialized manufacturing strategy analysis software is available specifically for this task. Either type of software can be deployed to analyze a company's manufacturing strategy during an audit led internally or by outside consultants. For example, auditors may obtain information from the software indicating that the company's customers are concentrated far from the company's current region of production. They could then run a simulation of what their overall costs would be if they moved their region of production closer to the customers taking into account the cost of the new factory, and the savings they would realize on shipping the product a shorter distance. This is a simple example. Management could probably detect the need to shift capacity to demand regions without specialized data analysis tools, and a team could probably evaluate the cost effect of such a shift using pens, paper, and a slide rule. However, modern global supply chain management must take into account a myriad of other factors, making the assistance of computerized systems essential.

There are several problems with current supply chain management systems and manufacturing strategy analysis systems when they are applied to analyze and optimize a global manufacturing strategy. The first problem is that the complexity and sheer number of factors affecting the global supply chain create a concomitantly complex data administration burden for assuring the system's accurate functionality. A company must not only keep track of all the internal information it needs to administrate its own supply chain such as a plant's fixed operating costs and a product's bill of materials, but it must also obtain data on aspects of the supply chain as far flung as the property tax rate in specific Japanese prefectures, or Australia's export tariff on specific raw materials. Aside from the burden on company personnel caused by the highly data intensive nature of these systems, the same personnel require extensive training to deal with the complexity of the software necessary to compare and analyze all of the different manufacturing strategies that can be implemented against this complex framework of possibilities. This problem is exacerbated by the fact that different systems will not function across different industries without extensive customization which can be both costly and time consuming. In addition, these systems are often designed externally and the associated software will therefore cost the company a great deal of money in the form of software licensing fees. Finally, current systems do not offer a streamlined process for comparing different scenarios given the different choices a global manufacturing strategist can make. Current systems allow for modification of variables associated with one set of decisions such as how to ship a product in a separate section from modification of variables associated with other decisions such as what the costs of production are in a certain region. Therefore, it is difficult to compare sets of manufacturing strategy decisions that span the full range of options available to the modern day global manufacturing strategist.

### SUMMARY OF INVENTION

In a specific embodiment of the invention, a computer-implemented method for analyzing a manufacturing scenario for an enterprise is provided. This method comprises a step of inputting a set of key cost inputs. The method additionally comprises a step of adjusting a set of manufacturing scenario levers to create a set of manufacturing scenario inputs. The method additionally comprises a step of synthesizing a scenario for simulation based on said set of manufacturing scenario inputs. The method additionally comprises a step of obtaining a result of said scenario for said enterprise by simulating said scenario using said key cost inputs.

In another embodiment a computer system for comparing manufacturing scenarios for an enterprise is provided. This system comprises a set of manufacturing scenario levers configured to take in a set of decisions regarding a potential manufacturing scenario. This system additionally comprises a set of key cost input modules configured to take in a set of key cost inputs regarding a current manufacturing operation. This system additionally comprises a scenario synthesis module configured to produce a synthesized manufacturing scenario based on said set of decisions. This system additionally comprises a manufacturing strategy simulation module configured to simulate said potential manufacturing scenario using said key cost inputs and said synthesized manufacturing scenario.

In another embodiment a computerized graphical-user-interface is provided. This graphical-user-interface comprises a set of key cost input buttons. This graphical-user-interface additionally comprises a set of manufacturing scenario levers. This graphical-user-interface additionally comprises a set of report level selectors.

### BRIEF DESCRIPTION OF DRAWINGS

FIG. 1 illustrates a block diagram of the functional blocks in a computer-implemented program that is consistent with the present invention.

FIG. 2 illustrates a process flow chart of a method that is consistent with the present invention.

FIG. 3 illustrates a block diagram of a graphical user interface that is consistent with the present invention.

### DETAILED DESCRIPTION OF THE PREFERRED EMBODIMENTS

The present invention allows for the seamless comparison of different global manufacturing strategies. Embodiments of the present invention advantageously exhibit a minimum input data requirement, allow for a simplified comparison of different strategies, and do not require custom designed software or specially trained personnel. Embodiments of the present invention attain these advantageous attributes by leveraging ubiquitous spreadsheet technology, carefully balancing input data requests with built-in estimations, balancing the flexibility and simplicity of possible strategy objectives, and presenting results in a simple streamlined fashion.

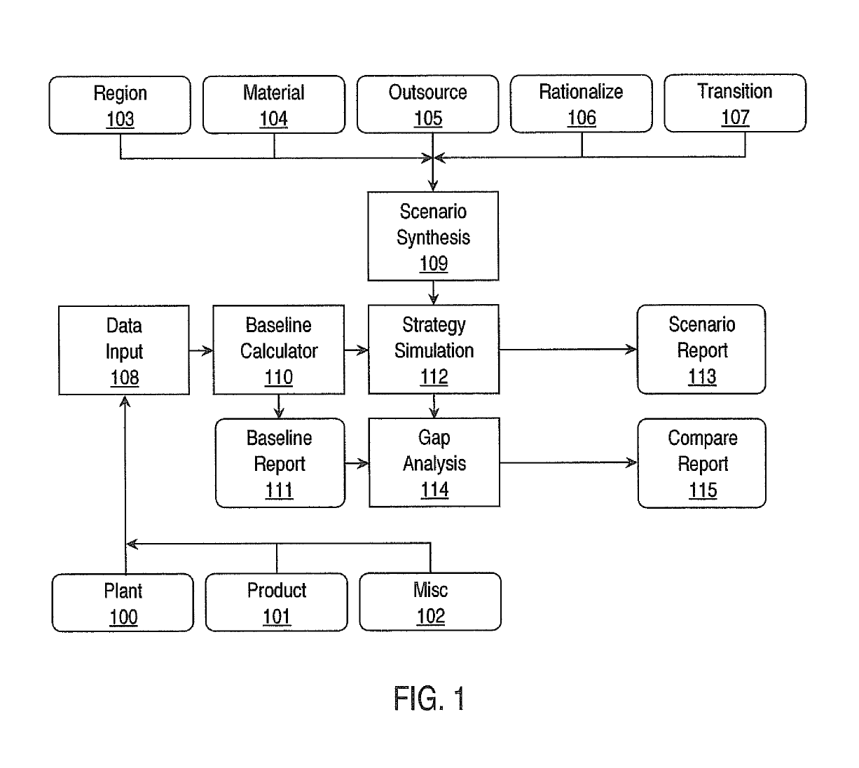

A specific embodiment of the invention can be described with reference to FIG. 1. FIG. 1 illustrates a block diagram of the functional blocks in a computer-implemented program that is consistent with the present invention. A user of the program will input key cost inputs and strategy objectives by adjusting a set of manufacturing scenario levers. The key cost inputs are plant inputs 100, product inputs 101, and miscellaneous inputs 102. The manufacturing scenario levers are regionalization lever 103, material source lever 104, outsource lever 105, rationalization lever 106, and transition cost lever 107. The key cost inputs are taken in by data input module 108, and the strategy objectives for a given scenario are inputted into the system by adjusting the manufacturing scenario levers and taking in information on these adjustments through scenario synthesis module 109. Once the key cost input data is taken in, data input module 108 provides baseline landed manufacturing cost calculator module 110 with enough information to generate baseline report 111. Once the strategy objectives are taken in, manufacturing strategy simulation model 112 will be able to take in the key cost inputs and the synthesized strategy objectives, and simulate the current scenario report 113. Finally, gap analysis module 114 compares baseline report 111 with the current scenario report to generate streamlined comparison report 115.

In specific embodiments of the invention, the key cost inputs are selected to minimize data input requirements and properly balance accuracy with simplicity. Key cost inputs such as plant inputs 100, product inputs 101, and miscellaneous inputs 102 are selected based on information that is most commonly available to companies that engage in manufacturing. Since this type of data does not require additional data acquisition efforts, the balance of costs and benefits of leveraging this type of data is ideal. Also, since this data is available to all companies that engage in manufacturing, a program embodying the invention does not need to be optimized for particular industries, and the related costs are eliminated.

In specific embodiments of the present invention, plant inputs 100 can comprise the fixed operating cost and available capacity of a company's manufacturing plants. For example, available capacity would indicate how many hours the plant was capable of running in a given month. Plant inputs could also include individual inputs for a plant name in text, a strategic business unit in text, a product produced at the plant in text, and location information regarding the plant in text. Plant inputs could also include allocated fixed costs overheats in dollars and a measure of the plants depreciation rate which could be given as a percentage. Another plant input could be the plant's lean rate on a five year horizon which could also be given as a percentage. Assumptions could accompany these inputs including corporate overheads, plant fixed costs, manufacturing fixed costs, the depreciation rate to be charged to allocated fixed cost overheads on a per annum basis, and a lean rate improvement factor for the plant.

In specific embodiments of the present invention, product inputs 101 can comprises the product demand profile, the product bill of materials, and the production rate. For example, the product demand profile indicates the market rate of the product in various markets given the company's level of output of the product, the bill of materials indicates the cost of the product's component parts. The production rate indicates how many hours it takes to produce each unit. Product inputs could also be split into variable cost, high level bill of material categories, manufacturing stage inputs, demand inputs, and inventory inputs. Variable cost inputs would include the cost of raw materials in dollars, labor costs in dollars, and variable overhead costs in dollars which could include indirect labor. High level bill of material category inputs could be provided in terms of a percentage of their age. Manufacturing stage inputs could include a binary value indicating if multistage manufacturing was decided upon, and could also include stage-wise machine capacity inputs in hours. Inventory inputs would include work in progress in dollars, raw material costs in dollars, and finished goods inputs in dollars. Demand inputs could include baseline demand as a number of units and the growth rate of demand for a time horizon of interest as a percentage.

In specific embodiments of the present invention, miscellaneous inputs 102 can comprise associated labor costs, raw material costs, inventory carrying costs, variable overhead costs, and logistics costs. Miscellaneous inputs could also include internal sales with a value provided in dollars and a markup factor provided as a percentage.

In specific embodiments of the present invention, baseline landed manufacturing cost calculator module 110 can produce baseline report 111 based on the key cost inputs 100, 101, and 102 for any given company. This report includes the full burn labor rate (FBLR), capacity utilization of the company's manufacturing capabilities, the finished goods (FG) cost per unit, and various cost views for different levels of the company. The fact that these reports can be geared to different levels of the company such as the global, divisional, regional, plant, and product category levels increases the tool's utility while at the same time minimizing complexity because a user can choose to only be presented with the information that is necessary for their level of interest.

In specific embodiments of the present invention, the scenario levers are selected to minimize data input requirements and properly balance the flexibility and simplicity of possible strategy objectives. Regionalization lever 103 relates to where the company's factories products are produced. In a specific embodiment of this invention, this can lever can affect how production is distributed among a company's already existing production facilities. In other embodiments of the invention, there can be individual entries for different factories or a single region can be chosen if all manufacturing takes place in one region. Material source lever 104, relates to where the raw materials and components parts of the manufactured product originate. Similarly to region lever 103, materials source lever 104 can have many different components as there may be as many individual components as there are individual materials in the finished manufactured product. Outsource lever 105 is an indicator of how much outsourcing is conducted. This value van range from 0 to 100%, and may also be more complex and be applied towards specific products in a company's portfolio and not just one. The lever can additionally be applied to take in strategy objectives related to outsourcing labor or entire manufacturing facilities. Rationalization lever 106 can take in strategy objectives regarding whether or not the company will create a new factory, warehouse, or distribution chain and the costs that will go along with that decision. Transition costs lever 107 relates to strategy objectives regarding moving the company's production locations, and will provide the simulation with information on the costs associated with moving a factory from one location to a newly rationalized factory.

In specific embodiments of the invention, outsource lever 105 can comprise business logic for determining the viability of a scenario involving outsourcing. Outsource lever 105 in combination with manufacturing strategy simulation module 112 could implement business logic to determine outsourcing viability by determining if total per unit burdened internal labor costs are greater than per unit vendor quoted costs. If so, then outsourcing should be implemented for those product categories. Under this analysis, total per unit burdened internal labor costs are equal to gross labor expense plus fixed allocated overhead plus the quantity that is variable overheads divided by the number of units produced.

Nearly any global manufacturing strategy objective can be broken into strategy decisions represented by the scenario levers described above. These strategy decisions will then be simulated through the use of scenario synthesis module 109. For example, regionalization lever 103 could be used to model a shift in capacity to demand regions, a move to a multi-source manufacturing model for specific product lines, or the creation of a central manufacturing model with multi-product capability. Outsource lever 105 could be used to synthesize a simulation of cost effective country sourcing, the development of turn-key suppliers for commodity products, and the effect of increased supply chain costs associated with supplier activity. Material source lever 104 could be used to synthesize a simulation to show independent savings for different types of components, additional costs incurred from increased procurement activities, and the movement of sources of raw materials. These simulations may be able to show the total laded cost of materials cost calculation for a time horizon of interest including material, labor, transportation, customs, tax, and inventory storage costs. Rationalization lever 106 could be used to synthesize a simulation to show an increase in a company's overall production capacity, the development of a new facility for production, or the replacement of the existing productive capacity of a facility using another facility. Scenario synthesis module 109 can then produce a multitude of possible scenarios of potential global manufacturing strategy objectives resulting from a combination of inputs from the scenario levers, including any combination of the examples described above. Breaking down the possible global manufacturing strategy objectives into individual levers provides for flexibility owing to the great number of possible combinations of these levers, and at the same time preserves the simplicity of the model because each component lever can be analyzed, altered, and applied separately.

In specific embodiments of the invention, the scope of the set of scenario levers is selected such that the overall model is agnostic to a user's industry. This is in keeping with the decision for the range of key cost inputs in specific embodiments of the invention discussed above. Regardless of whether a company is producing pens or cars they have to deal with things like their source of raw materials, which can be adjusted using material source lever 104, and the cost of building a new factory which can be adjusted using rationalization lever 106. All of the scenario levers relate to decisions that are faced by all industries and are common to all manufacturing enterprises. In addition, the levers are available in a single level of the programming interface so any manufacturing strategy objective can be entered by dissecting it into its effect on each lever and entering it in a single location. This is an advantage over tools in the prior art where the effect of decisions on things like contract manufacturing have to be entered into the overall model at a different level of operation than the cost of building a new factory or changing a source of raw materials.

The operation of scenario synthesis module 109 is to take in all of the decisions made through the scenario levers and deliver them to manufacturing strategy simulation module 112 as a single package representing a specific manufacturing strategy scenario. As an example, scenarios could be run to discover revenue uplift wherein additional revenue is gained subject to the satisfaction of certain conditions. These conditions could broadly include lead time, quality, localized content, and localized manufacturing. In another example, a user may decide they want to see the effect of altering their global materials source for one input from China to Australia. In that case, this objective would be taken in through material source lever 104. It would then be synthesized to a scenario through scenario synthesis module 109 using data from a library of costs associated with this change in materials source. Synthesis module 109 would in fact contain data of this nature for any possible combination of objectives expressed by the scenario levers. It is the balance of data within this library and the key cost input data that is requested from the user that affords specific embodiments of the invention with both a minimal data input requirement and accurate reporting. Although the stored data may not represent a specific situation faced by a user due to variations among industries, the costs affecting aspects of the scenario levers are mostly agnostic to company and sector whereas the key cost inputs are highly company specific. Therefore, the described segmentation of cost affecting factors into the libraries utilized by synthesis module 109 and requested by data input module 108 efficiently combine low input data requirements with the production of an accurate result. Furthermore, the data within this library could be altered in order to take in variations in outside inputs affecting the business to further replicate business conditions.

In specific embodiments of the present invention, manufacturing strategy simulation module 112 will be implemented using ubiquitous spreadsheet technology. For example, manufacturing strategy simulation module 112 could be implemented using Microsoft Excel. In certain specific embodiments of the present invention, the implementation in ubiquitous spreadsheet technology would include a streamlined graphical user interface with buttons for all of the inputs, levers, and outputs discussed above. In certain specific embodiments of the present invention, all modules described in this specification can be implemented using the same spreadsheet technology such as Microsoft Excel. The benefit of using commonly available spreadsheet technology is that the model will be transparent to a user such that it can be tweaked and modified from its original form to adapt to a user's specific situation. In addition, the tool will not require specialized software and the accompanying high licensing fees because spreadsheet technology is already available to almost all businesses. Finally, there will not be a need to train or hire specialized personnel to operate the tool because most employees are already proficient in the use of spreadsheet technology.

In specific embodiments of the present invention, manufacturing strategy simulation module 112 will take in the key costs inputs and the synthesized strategy objectives, and simulate a scenario to produce current scenario report 113. This report includes the full burn labor rate (FBLR), capacity utilization of the company's manufacturing capabilities, the finished goods (FG) cost per unit, and various cost views for different levels of the company. The fact that these reports can be geared to different levels of the company such as the global, divisional, regional, and plant level increases the tools utility while at the same time minimizing complexity because a user will only be presented with the information that is necessary for their level of interest.

In specific embodiments of the present invention, the data produced by manufacturing strategy simulation module 112 is also utilized by gap analysis module 114 to compare the data produced by baseline landed manufacturing cost calculator module 110 to generate a streamlined comparison report 115. This report includes the net present value assessment of implementing the current scenario, as well as specific values such as the labor and material savings resulting from implementing the current scenario. The number of years used to estimate these values can be adjusted by the user, but can also be set to five years. The fact that a single streamlined comparison report 115 can be created for each scenario providing all the data in a single place for easy comparison is highly advantageous. Additional values can be made available in the report, but are advantageously limited to only those values that are absolutely essential to determine the benefit of a given scenario in order to limit the complexity of the result and most effectively facilitate complex decision making.

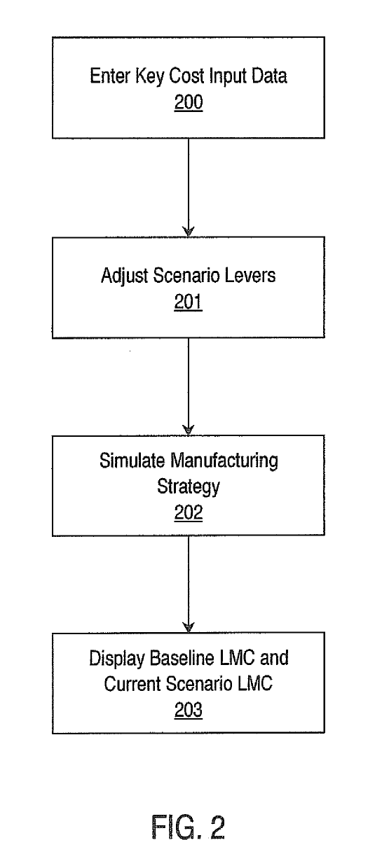

A specific embodiment of the invention can be described with reference to FIG. 2. FIG. 2 illustrates a process flow chart of a method that is consistent with the present invention. In step 200, key cost input data for calculation of a current manufacturing strategy is entered which is capable of producing a baseline landed manufacturing cost for such strategy. In step 201, lever values for a current manufacturing strategy scenario are entered using a set of manufacturing strategy scenario levers. In step 202, a current manufacturing strategy scenario is simulated based on stored data selected from the entered lever values and the key cost input data. In step 203, a baseline landed manufacturing cost and a current scenario landed manufacturing cost reports are displayed. The key cost input data input in step 200 can take on any of the characteristics of the key cost inputs discussed with reference to FIG. 1. The manufacturing scenario levers and lever values in step 201 can take on any of the characteristics of the manufacturing scenario levers discussed with reference to FIG. 1. Step 203 can additionally comprises displaying any of the data of the baseline report, streamlined comparison report, and current scenario report discussed with reference to FIG. 1.

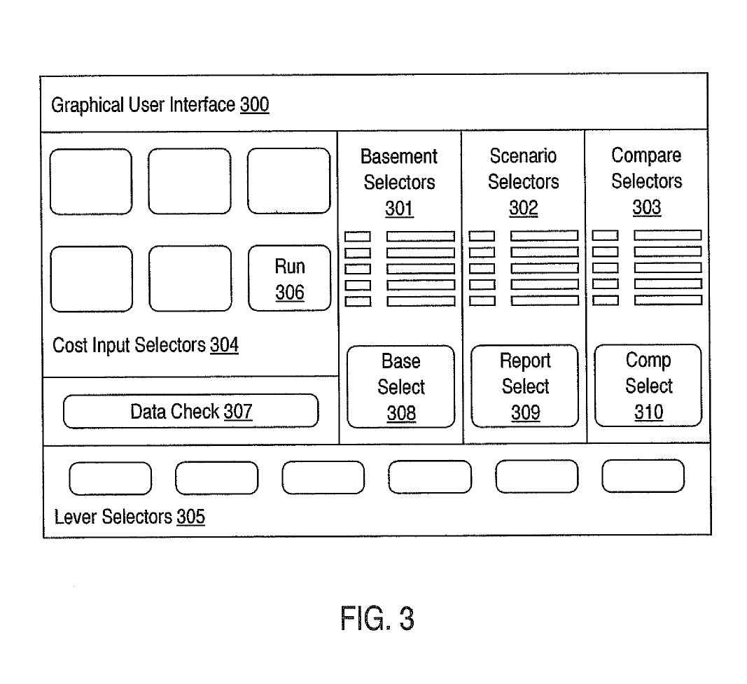

A specific embodiment of the invention can be described with reference to FIG. 3. FIG. 3 displays a graphical user interface 300 that is in accordance with the present invention. Each time a scenario is run, a user will select a level of interest under baseline selectors 301, scenario selectors 302, and compare selectors 303. Selectors 301-303 allow selection of different levels of the company such as the global, divisional, regional, and plant level. Baseline selectors 301 set the level of interest for the baseline report as discussed above with reference to FIG. 1. Scenario selectors 302 sets the level of interest for the current scenario report as discussed above with reference to FIG. 1. Compare selector 303 set the level of interest for the streamline comparison report as discussed above with reference to FIG. 1.

In a specific embodiment of the invention graphical user interface 300 will include cost input selectors 304. These buttons will allow access to pages for inputting key cost inputs such as the plant, product, and miscellaneous inputs discussed with reference to FIG. 1. In other specific embodiments of the invention graphical user interface 300 will include lever selectors 305 for accessing the manufacturing scenario levers necessary to input the information needed to analyze a potential manufacturing scenario. These lever selectors 305 will include a regionalization lever selector, material source lever selector, outsource lever selector, rationalization lever selector, and transition cost lever selector. In specific embodiments of the invention, once the manufacturing scenario information and the key cost inputs have been provided a user will be able to run a scenario by selecting run button 306. This will, in specific embodiments, pass the required information to the scenario synthesis module and baseline calculator to allow for the production of a baseline, current scenario, and streamlined comparison report as discussed above with reference to FIG. 1. In specific embodiments of the present invention, these reports could be brought up by selection of either baseline report select button 308, current scenario report select button 309, or streamlined comparison report button 310. In specific embodiments of the present invention, these generated reports would not automatically be brought to a user's attention until they were specifically called for using buttons 308-310 this would allow the user to focus only on the reports that were necessary for their current task to prevent the user from being overwhelmed.

In a specific embodiment of the present invention, a system for analyzing a manufacturing scenario for an enterprise that is in accordance with the present invention will comprise data integrity checks that will monitor the key cost inputs for validity or general data integrity. These checks could be applied before a simulation was run. Likewise these checks could be run after a simulation was run to double check that the simulation produced results with a desired level of data integrity. In a specific embodiment of the present invention, this functionality could be triggered in a graphical user interface by selecting data integrity check button 307 which would thereby allow a user to trigger when the described checks were run.

Although embodiments of the invention have been discussed primarily with respect to specific embodiments thereof, other variations are possible. Various configurations of the described system may be used in place of, or in addition to, the configurations presented herein. For example, specific modules were discussed as if they were semantically separate, but specific algorithms may function as part of more than a single module. Functions may be performed by hardware or software, as desired. In general, any diagrams presented are only intended to indicate one possible configuration, and many variations are possible. Those skilled in the art will also appreciate that methods and systems consistent with the present invention are suitable for use in a wide range of applications encompassing any involving logistics management. While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the spirit and scope of the present invention. Furthermore, those skilled in the art will appreciate that the foregoing description is by way of example only, and is not intended to limit the invention.

What is claimed is:

1. A computer-implemented method for analyzing a manufacturing scenario for an enterprise, comprising the steps of:
inputting a set of key cost inputs;
adjusting a set of manufacturing scenario levers to create a set of manufacturing scenario inputs;
synthesizing a scenario for simulation based on said set of manufacturing scenario inputs; and
obtaining a result of said scenario for said enterprise by simulating said scenario using said key cost inputs.

2. The computer-implemented method from claim 1, wherein said synthesizing is conducted by a generally available spreadsheet program.

3. The computer-implemented method from claim 1, wherein said key cost inputs are all taken from a set of data points that are available from a basic accounting statement of any manufacturing enterprise.

4. The computer-implemented method from claim 3, further comprising the step of producing a baseline landed manufacturing cost report based solely on said set of key cost inputs.

5. The computer-implemented method from claim 3, wherein said manufacturing scenario levers are selected such that an estimated variance in an accuracy of said result remains constant across a set of manufacturing industries.

6. The computer-implemented method from claim 3, wherein said manufacturing scenario levers comprise a regionalization lever, a material source lever, an outsource lever, a rationalization lever, and a transition cost lever.

7. The computer-implemented method from claim 6, wherein said set of key cost inputs comprises a set of plant inputs and a set of product inputs.

8. A computer system for comparing manufacturing scenarios for an enterprise, comprising:
a set of manufacturing scenario levers configured to take in a set of decisions regarding a potential manufacturing scenario;
a set of key cost input modules configured to take in a set of key cost inputs regarding a current manufacturing operation;
a scenario synthesis module configured to produce a synthesized manufacturing scenario based on said set of decisions; and
a manufacturing strategy simulation module configured to simulate said potential manufacturing scenario using said key cost inputs and said synthesized manufacturing scenario.

9. The computer system from claim 8, wherein said scenario synthesis module is provided by a generally available spreadsheet program.

10. The computer system from claim 8, wherein said set of key cost inputs is taken from a set of data points that are available from a basic accounting statement of any manufacturing enterprise.

11. The computer system from claim 8, further comprising a baseline calculator module configured to produce a baseline landed manufacturing cost report based solely on said set of key cost inputs.

12. The computer system from claim 11, further comprising a gap analysis module configured to produce a streamlined comparison report based on said baseline landed manufacturing cost report and a current scenario report produced by said manufacturing strategy simulation module.

13. The computer-implemented method from claim 8, wherein said manufacturing levers are selected such that an estimated variance in an accuracy of said result remains constant across a set of manufacturing industries.

14. The computer system form claim 8, wherein said manufacturing strategy simulation module produces a current scenario report for said potential manufacturing scenario at a set of levels of interest.

15. The computer system from claim 14, wherein said set of levels of interest selected comprise a global level, a divisional level, a regional level, a plant level, and a product level.

16. The computer-implemented method from claim 8, wherein said manufacturing scenario levers comprise a regionalization lever, a material source lever, an outsource lever, a rationalization lever, and a transition cost lever.

17. The computer-implemented method from claim 16, wherein said set of key cost inputs comprises a set of plant inputs and a set of product inputs.

18. A computerized graphical-user-interface comprising:
a set of key cost input buttons;
a set of manufacturing scenario levers; and
a set of report level selectors.

19. The computerized graphical-user-interface from claim 18, wherein said graphical-user-interface is provided by a generally available spreadsheet program.

20. The computerized graphical-user-interface from claim 19, wherein said key cost input buttons comprise a plant cost input button, a product cost input button, and a miscellaneous costs input button.
